(19) United States
(12) Patent Application Publication
(10) Pub. No.: US 2025/0141392 A1
(43) Pub. Date: May 1, 2025

(54) ADAPTIVE JUNCTION TEMPERATURE CONTROL FOR ELECTRIC MOTOR

(71) Applicant: GM GLOBAL TECHNOLOGY OPERATIONS LLC, Detroit, MI (US)

(72) Inventors: Vinod Chowdary Peddi, Shelby Township, MI (US); Tanvi Nagarale, Rochester Hills, MI (US)

(73) Assignee: GM GLOBAL TECHNOLOGY OPERATIONS LLC, Detroit, MI (US)

(21) Appl. No.: 18/494,757

(22) Filed: Oct. 25, 2023

(51) Int. Cl. H02P 29/68; B60L 50/51; B60L 50/60; H02P 21/22; H02P 27/08

(52) U.S. Cl. CPC H02P 29/68; B60L 50/51; B60L 50/60; H02P 21/22; H02P 27/08

(57) ABSTRACT

A motor control system including an inverter having a diode and a transistor for generating an alternating current in response to a pulse width modulated direct current having a fixed amplitude and a processor configured to adjust a zero vector of the pulse width modulated direct current in response to a diode temperature and a transistor temperature such that the diode temperature equals the transistor temperature.

### INTRODUCTION

The present disclosure generally relates to controlling vehicle systems in response to a prediction of thermal stress in an electric motor, and more particularly relates to a method and apparatus for adaptive junction temperature control for enhanced stall torque and noise vibration and harshness performance at vehicle low speed high load conditions electric vehicles.

Electric motors are used in electric vehicles (EV) to convert electrical energy from the battery into mechanical energy to turn the wheels. Typically there are two main types of electric motors used in EVs: induction motors and permanent magnet synchronous motors (PMSMs). Induction motors are the most common type of electric motor used in EVs. They are relatively simple and inexpensive to manufacture. Induction motors are also very efficient, and they can provide a high torque output. PMSMs are more expensive than induction motors, but they are also more efficient and offer better performance. PMSMs are often used in high-performance EVs, such as sports cars and racing cars. Modern EVs typically have two electric motors, one for each axle, but some EVs can have a single motor located under the hood or four motors, one for each wheel.

While the need to protect vehicle operation during damaging or destructive operating conditions is clear, it is desirable that any vehicle protect algorithms be used optimally to provide the maximum protection to the vehicle while continuing to provide service to a driver. It is desirable to overcome the aforementioned problems in order to provide systems and methods for vehicle system protection and continued vehicle operation for vehicle propulsion and driver assistance systems. Furthermore, other desirable features and characteristics of the present invention will become apparent from the subsequent detailed description and the appended claims, taken in conjunction with the accompanying drawings and the foregoing technical field and background.

### SUMMARY

Disclosed herein are vehicle control methods and systems and related electrical systems for provisioning motor systems, methods for making and methods for operating such systems, and motor vehicles and other equipment such as aircraft, ships, wind turbines and other EVs equipped with onboard propulsion systems. By way of example, and not limitation, there are presented various embodiments of systems for balancing thermal stress in a three phase inverter occurring during stall conditions for electric vehicle motors.

[This Section to be Completed after Claim Approval]

### BRIEF DESCRIPTION OF THE DRAWINGS

The exemplary embodiments will hereinafter be described in conjunction with the following drawing figures, wherein like numerals denote like elements, and wherein:

FIG. 1 shows a control system associated with a vehicle in accordance with various embodiments;

FIGS. 2A and 2B are diagrams depicting cross-sectional views of an exemplary electric machine from two different perspectives in accordance with various embodiments;

FIG. 3 shows an exemplary EV drive configuration in accordance with various embodiments;

FIG. 4 shows a block diagram illustrative of adaptive junction temperature control system for electric motor in accordance with various embodiments; and

FIG. 5 shows a flowchart illustrative of a method for operating an exemplary adaptive junction temperature control for electric motor systems in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application-specific integrated circuit (ASIC), a field-programmable gate array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, lookup tables, or the like, which may carry out a variety of functions under the control of one or more microprocessors or other control devices. In addition, those skilled in the art will appreciate that embodiments of the present disclosure may be practiced in conjunction with any number of systems and that the systems described herein are merely exemplary embodiments of the present disclosure.

For the sake of brevity, conventional techniques related to signal processing, data transmission, signaling, control, machine learning, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

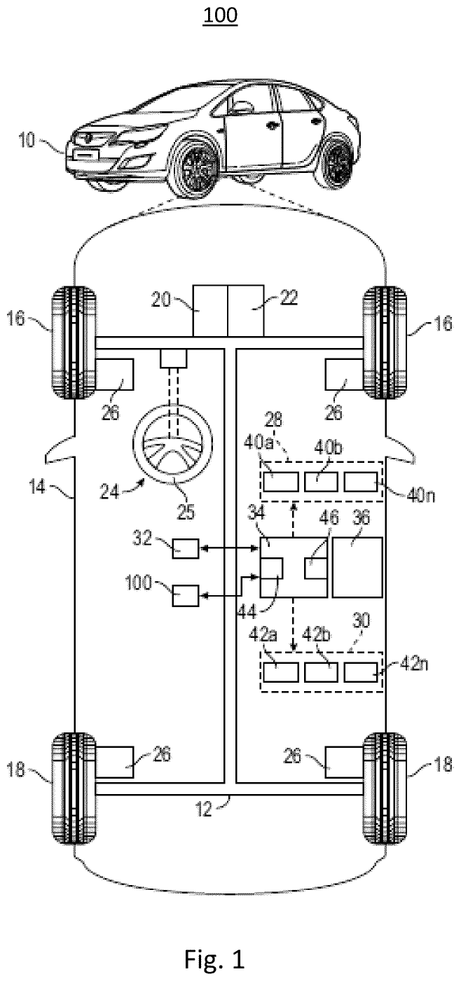

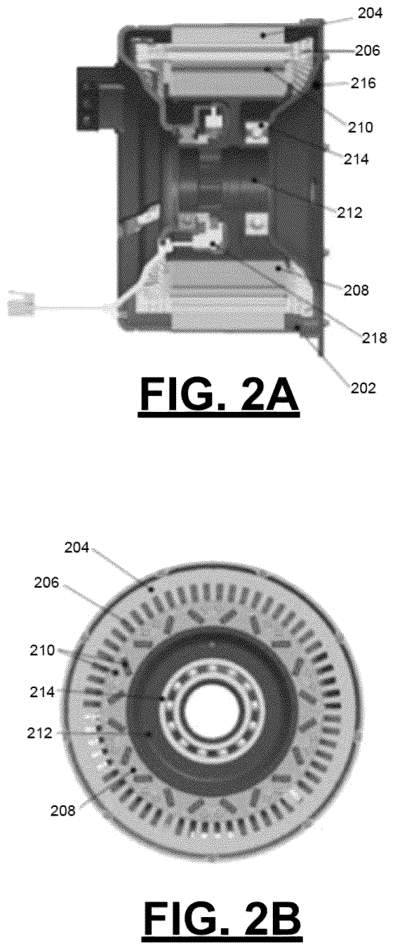

With reference to FIG. 1, a control system 100 is associated with a vehicle 10 (also referred to herein as a “host vehicle”) in accordance with various embodiments. In general, the control system (or simply “system”) 100 provides for control of various actions of the vehicle 10 (e.g., torque control) established by Reinforcement Learning (RL) which is or can be stored in a DNN type model that controls operation in response to data from vehicle inputs, for example, as described in greater detail further below in connection with FIGS. 2-4.

In various exemplary embodiments, system 100 provides a process using an algorithm that controls torque and speed in a host vehicle's 10 embedded controller software of the system 100 allowing DNNs to be used for an ACC behavior prediction model. The system 100 enables learning of driver's preference for following distance for different vehicles such a target vehicle and to classify driver's preference based on driving scenarios; e.g., traffic signs, stop and go traffic, city driving, etc. The system 100 uses a Q-matrix to build a knowledge base for target vehicles following a performance preference by utilizing online and historical driver and environmental information.

As depicted in FIG. 1, vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14. In various embodiments, the wheels 16, 18 include a wheel assembly that also includes respectively associated tires.

In various embodiments, vehicle 10 is autonomous or semi-autonomous, and the control system 100, and/or components thereof, are incorporated into the vehicle 10. The vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, and the like, can also be used.

As shown, the vehicle 10 generally includes a propulsion system 20, a transmission system 22, a steering system 24, a brake system 26, a canister purge system 31, one or more user input devices 27, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmissions.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences the position of the vehicle wheels 16 and/or 18. While depicted as including a steering wheel for illustrative purposes, in some embodiments contemplated within the scope of the present disclosure, the steering system 24 may not include a steering wheel.

The controller 34 includes at least one processor 44 (and neural network 33) and a computer-readable storage device or media 46. As noted above, in various embodiments, the controller 34 (e.g., the processor 44 thereof) provides data pertaining to a projected future path of the vehicle 10, including projected future steering instructions, to the steering control system 84 in advance, for use in controlling steering for a limited period of time in the event that communications with the steering control system 84 become unavailable. Also, in various embodiments, the controller 34 provides communications to the steering control system 84 via the communication system 36 described further below, for example, via a communication bus and/or transmitter (not depicted in FIG. 1).

In various embodiments, controller 34 includes at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chipset), any combination thereof, or generally any device for executing instructions. The computer-readable storage device or media 46 may include volatile and non-volatile storage in read-only memory (ROM), random-access memory (RAM), and keep-alive memory (KAM), for example. KAM is a persistent or non-volatile memory that may be used to store multiple neural networks, along with various operating variables, while the processor 44 is powered down. The computer-readable storage device or media 46 may be implemented using any of a number of known memory devices such as PROMs (programmable read-only memory), EPROMS (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the processor 44, receive and process signals from the sensor system 28, perform logic, calculations, methods, and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

As depicted in FIG. 1, the vehicle 10 generally includes, in addition to the above-referenced steering system 24 and controller 34, a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14. In various embodiments, the wheels 16, 18 include a wheel assembly that also includes respectively associated tires.

In various embodiments, the vehicle 10 is an autonomous vehicle, and the control system 100, and/or components thereof, are incorporated into the vehicle 10. The vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, and the like, can also be used.

The controller 34 includes a vehicle controller that operates based on the neural networks 33 model's output. In an exemplary embodiment, a feed-forward operation can be applied for an adjustment factor that is the continuous output of the neural network 33 models to generate a control action for the desired torque or other like action (in case of a continuous neural network 33 models, for example, the continuous APC/SPARK prediction values are outputs).

In various embodiments, one or more user input devices 27 receive inputs from one or more passengers (and driver 11) of the vehicle 10. In various embodiments, the inputs include a desired destination of travel for the vehicle 10. In certain embodiments, one or more input devices 27 include an interactive touch-screen in the vehicle 10. In certain embodiments, one or more input devices 27 include a speaker for receiving audio information from the passengers. In certain other embodiments, one or more input devices 27 may include one or more other types of devices and/or maybe coupled to a user device (e.g., smartphone and/or other electronic devices) of the passengers.

The sensor system 28 includes one or more sensors 40a-40n that sense observable conditions of the exterior environment and/or the interior environment of the vehicle 10. The sensors 40a-40n include but are not limited to, radars, lidars, global positioning systems, optical cameras, thermal cameras, ultrasonic sensors, inertial measurement units, and/or other sensors.

The actuator system 30 includes one or more actuators 42a-42n that control one or more vehicle features such as, but not limited to, canister purge system 31, the intake system 38, the propulsion system 20, the transmission system 22, the steering system 24, and the brake system 26. In various embodiments, vehicle 10 may also include interior and/or exterior vehicle features not illustrated in FIG. 1, such as various doors, a trunk, and cabin features such as air, music, lighting, touch-screen display components (such as those used in connection with navigation systems), and the like.

The data storage device 32 stores data for use in automatically controlling the vehicle 10, including the storing of data of a DNN that is established by the RL, used to predict a driver behavior for the vehicle control. In various embodiments, the data storage device 32 stores a machine learning model of a DNN and other data models established by the RL. The model established by the RL can take place for a DNN behavior prediction model or RL established model (See. FIG. 2, DNN prediction model or RL prediction model). In an exemplary embodiment, no separate training is required for the DNN rather, the DNN behavior prediction model (i.e., DNN prediction model) is implemented with a set of learned functions. In various embodiments, the neural network (i.e., DNN behavior prediction model) may be established by RL or trained by a supervised learning methodology by a remote system and communicated or provisioned in vehicle 10 (wirelessly and/or in a wired manner) and stored in the data storage device 32. The DNN behavior prediction model can also be trained via supervised or unsupervised learning based on input vehicle data of a host vehicle operations and/or sensed data about a host vehicles operating environment.

The data storage device 32 is not limited to control data, as other data may also be stored in the data storage device 32. For example, route information may also be stored within data storage device 32—i.e., a set of road segments (associated geographically with one or more of the defined maps) that together define a route that the user may take to travel from a start location (e.g., the user's current location) to a target location. As will be appreciated, the data storage device 32 may be part of controller 34, separate from controller 34, or part of controller 34 and part of a separate system.

Controller 34 implements the logic model established by RL or for the DNN based on the DNN behavior model that has been trained with a set of values, includes at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chipset), any combination thereof, or generally any device for executing instructions. The computer-readable storage device or media 46 may include volatile and non-volatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the processor 44, receive and process signals from the sensor system 28, perform logic, calculations, methods, and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

The communication system 36 is configured to wirelessly communicate information to and from other entities 48, such as but not limited to, other vehicles (“V2V” communication), infrastructure (“V2I” communication), remote transportation systems, and/or user devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

In various embodiments, the communication system 36 is used for communications between the controller 34, including data pertaining to a projected future path of the vehicle 10, including projected future steering instructions. Also, in various embodiments, the communication system 36 may facilitate communications between the steering control system 84 and/or more other systems and/or devices.

In certain embodiments, the communication system 36 is further configured for communication between the sensor system 28, the input device 27, the actuator system 30, one or more controllers (e.g., the controller 34), and/or more other systems and/or devices. For example, the communication system 36 may include any combination of a controller area network (CAN) bus and/or direct wiring between the sensor system 28, the actuator system 30, one or more controllers 34, and/or one or more other systems and/or devices. In various embodiments, the communication system 36 may include one or more transceivers for communicating with one or more devices and/or systems of the vehicle 10, devices of the passengers (e.g., the user device 54 of FIG. 2), and/or one or more sources of remote information (e.g., GPS data, traffic information, weather information, and so on).

FIGS. 2A and 2B are diagrams depicting cross-sectional views of an exemplary electric machine 200 from two different perspectives. The exemplary electric machine 200 includes a housing 202 surrounding the example electric machine 200 and a stator stack 204 within the housing 202. The example stator stack 204 includes a plurality of windings 206 around an inner periphery of the stator stack 204. Enclosed within the exemplary stator stack 204 is a rotor stack 208. The example rotor stack 208 includes a plurality of magnets 210 and a rotor hub 212. The example rotor stack 208 is configured to rotate within the stator stack 204 using a set of bearings 214. The example stator stack 204 and example rotor stack 208 are enclosed within the housing 202 by an end cover 216. The example electric machine 200 further includes a resolver 218 for measuring the degrees of rotation of the rotor stack 208.

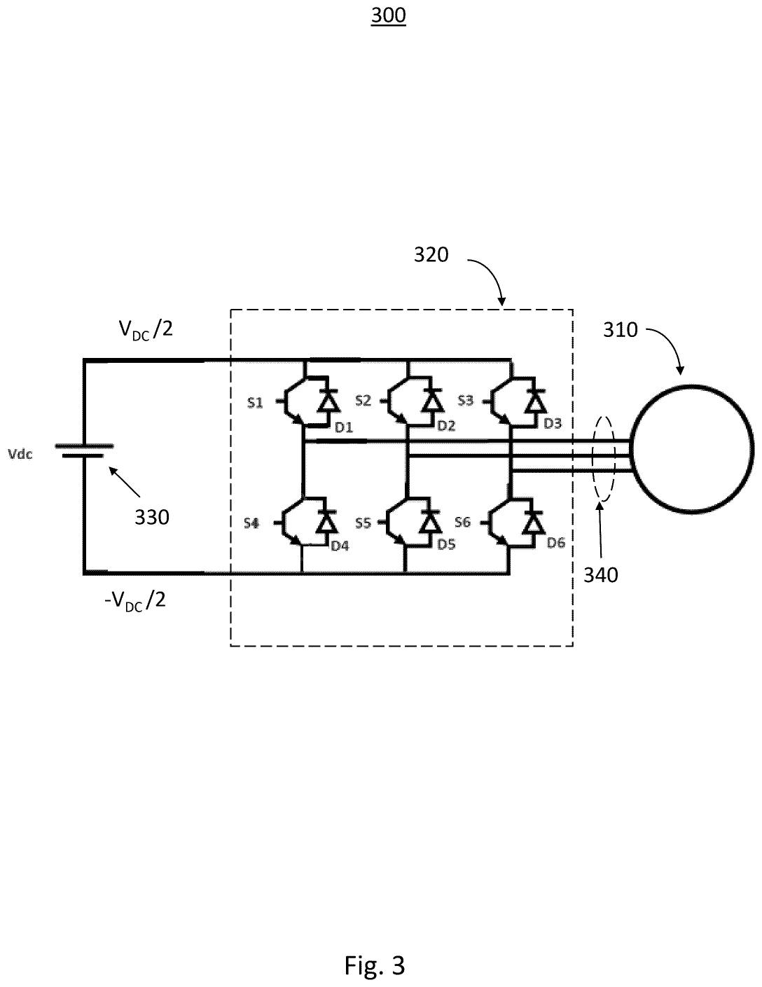

Turning now to FIG. 3, an exemplary EV drive configuration 300 according to exemplary embodiments of the present disclosure is shown. EVs are configured with one or more electric motors. For example, all-wheel drive EVs may have a motor for each axle. This allows for better traction and control on slippery surfaces. The most common types of electric motors used in EVs are permanent magnet synchronous motors (PMSMs) and induction motors. PMSMs are the most efficient type of electric motor and are used in most modern EVs due to their high torque output and low noise and vibration levels. PMSMs use permanent magnets to create a rotating magnetic field that drives the rotor. Lower cost induction motors are less efficient than PMSMs but can be more reliable. Induction motors use a rotating magnetic field to induce a current in the rotor windings, which causes the rotor to turn.

The electric motor 310 is typically powered using a three phase alternating current (AC) current. Electric motors can be supplied with either single-phase or three-phase AC electricity. Single-phase induction motors are less common than three-phase induction motors, and they are typically used in smaller applications. Three-phase induction motors are more common and are used in larger applications, such as EVs and industrial machinery. Three-phase electric motors are more efficient than single-phase motors and are also able to produce more torque. This makes them ideal for use in applications where high power and efficiency are required, such as EVs.

The exemplary three phase inverter 320 is supplied a DC voltage from a direct current (DC) voltage source, such as a battery 330 and converts the DC electricity into three-phase alternating current (AC) electricity 340. Three-phase AC electricity 340 has three separate voltages that are out of phase by 120 degrees. To power the electric motor 310, the inverter 320 supplies the motor with three-phase AC electricity 340 to the stator windings of the electric motor 310, which creates a rotating magnetic field in the stator. The rotating magnetic field then induces a current in the rotor windings, which causes the rotor to turn. The speed of the rotor is determined by the frequency of the three-phase AC electricity 340 supplied by the inverter 320. The higher the frequency, the faster the rotor will turn. The inverter 320 can also control the torque output of the electric motor 310 by adjusting the voltage of the three-phase AC electricity 340. In some exemplary embodiments, the switching signals applied to the plurality of transistors S₁-S₆ and the DC voltage can then be controlled in response to the estimated position of the rotor of the electric motor 310.

In some exemplary embodiments, the plurality of transistors S₁-S₆ can be arranged in a bridge configuration. The bridge circuit can be made up of six semiconductor switches S₁-S₆ such as insulated-gate bipolar transistors (IGBT) or metal-oxide-semiconductor field-effect transistors (MOSFET). The switches are turned on and off in a sequence that creates three-phase AC voltages 340 at the output of the bridge circuit. The three-phase AC voltages are then supplied to the stator windings of the electric motor 310. The rotating magnetic field in the stator induces a current in the rotor windings, which causes the rotor to turn.

Body diodes D₁-D₆ in a three-phase inverter 320 provide a path for the inductive load current to flow during dead time. The dead time is a short period of time between when one switch is turned off and the other switch in the same phase is turned on prevent shoot-through, which is when both switches are turned on at the same time, creating a short circuit. In IGBT based three-phased inverters 320, body diodes play equal part in conduction. As IGBTs are not bi-directional, diodes conduct to continue flow of current. For positive current, upper IGBT and lower diode conduct and for negative current, lower IGBT and upper diode conduct. Therefore, their role is not limited to dead-time for IGBT based inverter and hence diodes and their thermal characteristics are important in order to manage thermal stress of inverter.

Issues can arise when the electric motor 310 experiences a stall condition, such as when starting to move when trailering a heavy load or starting to move while on a hill. Stall conditions occur when electric power is being applied to one or more of the three phase windings, but the motor 310 is not rotating. When a motor 310 stalls, all of the electrical power that is applied to it is converted into heat. This can quickly overheat the motor 310, causing damage to the windings, insulation, and other components. Similarly, the amount of current that a motor 310 draws when it is unable to rotate is typically much higher than the motor's 310 running current. This high current draw can overload the motor's 310 controller and other electrical components. Damage resulting from motor 310 stall damage the motor 310 shaft, bearings, and other components and reduce the motor's 310 overall performance and lifespan.

PWM modulation, such as adaptive temperature balancing PWM modulation, is used to reduce thermal stress on the semiconductor switches S₁-S₆ to allow for acceptable switching noise levels and to diminish potential damage due to motor stall. However, at stall, using discontinuous PWM can result in NVH issues and inadequate thermal distribution. Inadequate thermal distribution also happens at continuous PWM but without NVH issues. Thermal stress can become unevenly distributed among the switching transistors S₁-S₆ and body diodes D₁-D₆, with the hottest device varying based on the rotor position. In discontinuous PWM, the modulating signal is clamped to the DC-rail for a portion of each period. This can be done by using a discontinuous triangular carrier wave or by using a continuous triangular carrier wave and adding a zero-sequence voltage to it.

To address the unevenly distributed thermal stresses and potential NVH issues arising from the use of discontinuous PWM, the heat distribution of the various components can be estimated and the zero vector, and therefore the duty distribution between the devices, can be adaptively changed for more even heat distribution between the switching transistors S₁-S₆ and body diodes D₁-D₆. For example, in the exemplary EV drive 300, a steady state position drives 3-phase AC currents such that-1120A flows through a first phase and +560A flows through a second and third phase. Here the first phase is the highest current carrying phase. As current flowing through the first phase is negative, the conducting devices of the first phase are body diode D₁ and transistor S₄. In some exemplary embodiment based on inverter 320 and motor 310 states for a space vector pulse width modulation SVPWM scheme, the first phase duty is 0.45 for upper devices and 0.55 for lower devices. For this exemplary duty distribution, transistor S₄ can be conducting more than body diode D₁ while detected temperatures indicate that body diode D₁ has a higher temperature, such as 160° C. and transistor S₄ has a lower temperature, such as 145° C. This uneven heat distribution can be a result of differences in thermal characteristics between the body diode D₁ and transistor S₄. The exemplary algorithm is configured to rebalance the heat between body diode D₁ and transistor S₄ by adaptively changing the zero vector. In some exemplary embodiments, the duties are redistributed such that body diode D₁ duty reduces from 0.45 to 0.4 and transistor S₁ increases from 0.55 to 0.6. This redistribution results in a balanced temperature, such as ˜155° C. In some exemplary embodiments the exemplary algorithm can balance the heat dissipation between upper & lower devices of the same highest current carrying phase or can balance the heat dissipation between the hottest devices of the highest and second highest current carrying phases.

Changing the zero vector for PWM involves employing a different combination of switching states to represent the zero vector. In a three-phase inverter, there are six possible switching states, and each switching state represents a different combination of phase voltages. The zero vector is represented by the switching state where all three phases are connected to the same DC rail. One common method to change the zero vector for PWM is to use a space vector modulation (SVM) algorithm. Alternatively, carrier-based PWM algorithms can be used to generate a PWM signal by comparing the reference voltage waveform to a triangular carrier waveform.

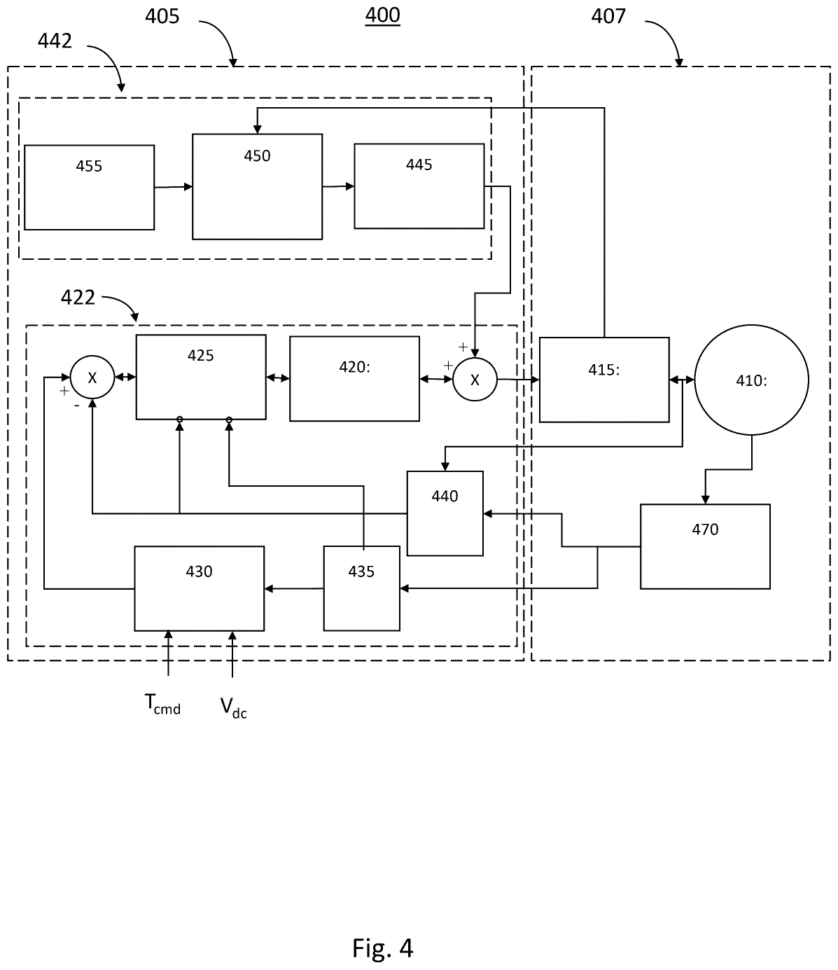

Turning now to FIG. 4, a block diagram illustrative of an adaptive junction temperature control system 400 for an electric drive 410 in accordance with various embodiments is shown. The exemplary adaptive junction temperature control system 400 includes a physical system 407 and a discrete control system 405. The exemplary physical system can include an electric drive motor 410, a PWM inverter 415 and a position sensor 470 to determine a position of the electric drive motor 410. The discrete control system 405 includes a PWM generation portion 422 and an adaptive junction temperature control portion 442.

The PWM generation portion 422 is configured to generate PWM power to supply to the PWM inverter by using a pulse width modulation (PWM) inverter 415. This PWM power is operative to convert the battery's DC voltage V_{dc} to a PWM voltage which is applied to the PWM inverter 415 to generate the 3 phaser AC power supplied to the electric drive 410. The duty cycle is the ratio of the on-time to the off-time of the voltage which determines the average voltage applied to the motor. By varying the duty cycle, the PWM generator 420 can control the speed and torque of the electric drive 410.

The DC voltage V_{dc} is coupled from the battery to the command generation module 430 which is configured to generate the stator current I_{dq} in response to the DC voltage V_{dc}, the electrical angular frequency ω_{c} and the controller cycle time T_{cmd}. The electrical angular frequency ω_{c} is generated in response to a differentiation 435 of the electric drive position Ø_{c}. The stator current I_{dq} is then corrected in response to errors from the drive current I_{abc} determined proportionate 440 to the electric drive position Ø_{c} received from the position sensor 470. The corrected stator current is then regulated by the current regulator 425 and the PWM waveform with an initial zero vector S_{abc} is generated from by the PWM generator 420.

The adaptive junction temperature control portion 442 is configured to generate an adapted zero vector S_{adapt} to rotate the initial zero vector S_{abc} to generate the final zero vector Sf_{abc}. The adapted zero vector is generated in response to estimated inverter losses 455 and estimated junction temperatures 450. Estimated inverter losses 455 can be determined using analytical, simulated or experimental methods and are estimated for the particular inverter configuration in response to predicted losses of inverter components. These inverter losses 455 can be estimated for different operating conditions and can be stored in a memory or lookup table, or can be used to generate a predictive algorithm for estimating the inverter losses for a current inverter operating condition. The estimated junction temperatures 450 can be estimated for particular transistor/body diode pairs to determine max junction temperatures.

The zero vector adaption 455 generates the adapted zero vector S_{adapt} in response to the peak current and mid current from the drive current I_{abc} for the presently conducting body diode and transistor pair. In some exemplary embodiments, the zero vector adaption 455 can first estimate an intermediate zero vector in response to body diode and transistor condition losses at peak currents, estimate the junction temperatures and diode temperatures in response to these intermediate zero vectors, estimate intermediate zero vectors at mid currents, and then generate the adapted zero vector S_{adapt} in response to an optimal ratio of the intermediate zero vectors resulting in balanced junction and diode temperatures for particular transistor and body diode pairs. The final zero vector is then generated in response to the adapted zero vector S_{adapt} and the initial zero vector S_{abc}. The final zero vector s_{f} is then used to adjust the stator current I_{dq} applied to the PWM inverter 415.

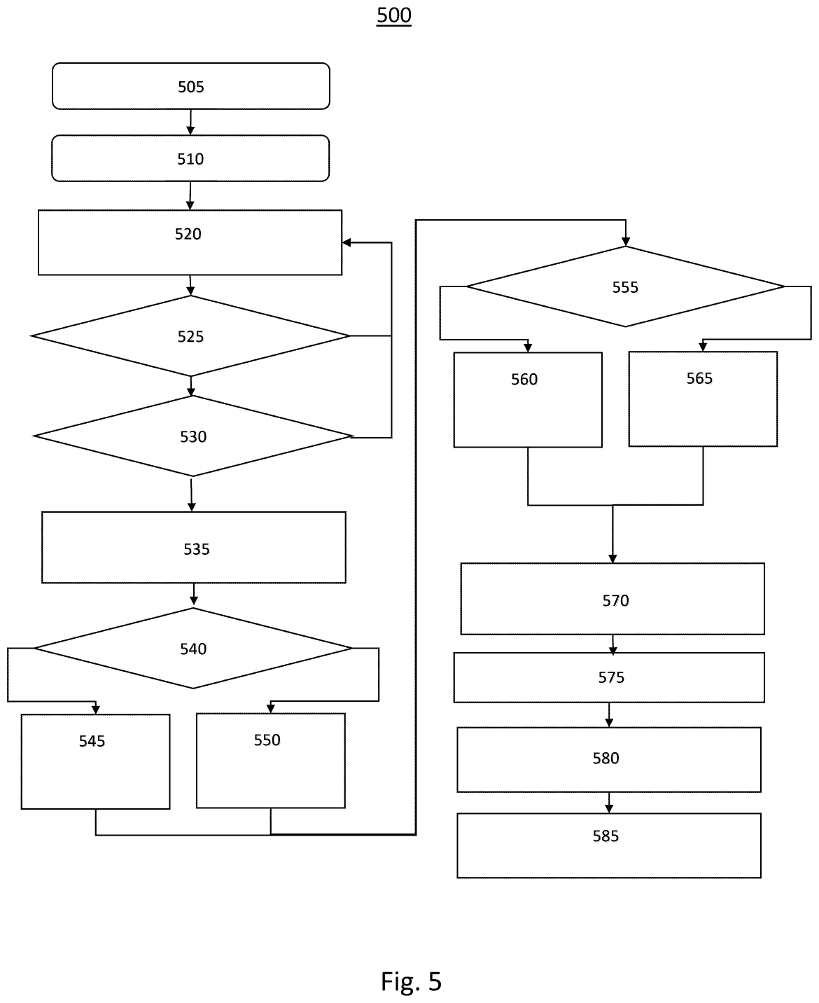

Turning now to FIG. 5, a method 500 for operating an exemplary adaptive junction temperature control for electric motor systems in accordance with various embodiments is shown. The exemplary method 500 is first operative to estimate inverter losses. Inverter losses in a 3-phase PWM inverter for an EV drive motor can be first estimated by identifying the inverter components. These components can include semiconductor switches, like IGBTs or MOSFETS, gate drivers, body diodes, inductors, capacitors and resistors. The inverter operating conditions are next considered including the input DC voltage, output AC voltage and frequency, modulation index, and load current. The inverter losses can then be estimated in response to the inverter components and the inverter operating conditions when the semiconductor switches are turned on. These inverter losses can then be stored in a memory or the like communicatively coupled to a processor or a controller for performing the adaptive temperature control for electric motor algorithm.

Once the inverter losses are estimated, the method 500 can next initiate 510 the algorithm. The algorithm can be initiated in response to a vehicle control system being initiated, a vehicle run state being transitioned from a standby state to a run state, or a vehicle drive state being transitioned from a “park” state to a “drive” state or the like. In some exemplary embodiments, the algorithm is operative to detect a stall state of an electric motor and to perform the adaptive temperature control in response to the detected stall state.

The exemplary method can utilize continuous PWM with zero vector adaptation based on junction temperature estimation-based model reference adaptive systems (MRAS) to achieves precise thermal balancing among all 12 devices adapting to change in rotor position while resolving NVH issues with use of continuous PWM. This adaptive approach advances reliable operation of the electric drives during hill hold, heavy load take off or other motor stall conditions while minimizing of both thermal stress and switching noise is achieved without any additional calibration effort.

The method 500 is configured to first estimate 520 junction temperatures for each of the various inverter components. In some exemplary embodiments, the method 500 can estimate the temperature of each of the six transistors and each of the six body diodes of a three phase inverter in response to the currents conducted through each of the inverter components and the corresponding inverter losses. Loss and temperature can be estimated individually for each device pair, transistor and body diode, and the maximum of these temperatures can be estimated.

In some exemplary embodiment, if 525 the max temperature of the power module Tₘₐₓ does not exceed a threshold temperature, such as when the vehicle motor is not in a stall condition or low current/low duty cycle PWM power is being conducted, the method 500 returns to estimating 520 subsequent junction temperatures. If the max temperature of the power module Tₘₐₓ exceeds the threshold temperature, the method 500 can next determine if the conducting diode temperature T_{diode} is not equal to the conducting transistor temperature Tₜᵣₐₙₛ. If the two temperatures are estimated to be equal, the method 500 returns to estimating 520 subsequent junction temperatures.

If 530 the conducting diode temperature T_{diode} is not equal to the conducting transistor temperature Tₜᵣₐₙₛ, indicative of an unbalanced temperature distribution throughout the conducting elements, the method 500 is next operative to sort the three phase currents based on the magnitude to determine the critical phases. The method 500 can sort the phase currents, A, B, and C, based on current magnitudes in order to determine the highest and second highest current carrying phase. The method then determines if 540 the highest critical phase current phase is greater than zero. If the highest critical phase current phase is greater than zero, the method 500 calculates 545 the first intermediate zero vector using the upper transistor and the lower diode loss information. If the highest critical phase current has a positive direction, the upper IGBT and lower diode are conducting. The method calculate the first intermediate zero vector considering loss information and device parameters of the upper IGBT and lower diode for that phase conduction path. If the highest critical phase current phase is less than zero, the lower IGBT and the upper diode are conduction. The method 500 then calculates 550 the first intermediate zero vector using the lower transistor and upper diode loss information.

After the first intermediate zero vector is calculated, the method then determines 555 it the diode temperature T_{diode} exceeds the transistor temperature Tₜᵣₐₙₛ. If the diode temperature T_{diode} exceeds the transistor temperature, the method 500 calculates 560 the second intermediate zero vector using the loss information of the diode in the highest critical phase and the 2^{nd} highest critical phase. If the diode is the hottest device, then the method calculates the second intermediate zero vector considering loss information and device parameters of the conducting diodes in the highest and second highest phase. If the diode temperature T_{diode} does not exceeds the transistor temperature, the method 500 calculates 565 the second intermediate zero vector using the loss information of the transistor in the highest critical phase and the 2nd highest critical phase. If the IGBT is the hottest device, then the method calculates the second intermediate zero vector considering loss information and device parameters of the conducting IGBTs in the highest and second highest phase.

Once the first intermediate zero vector and the second intermediate vector are calculated, the method 500 can then generate 570 an adapted zero vector in response to the estimated inverter losses, the estimated junction temperatures and/or the estimated electric currents. In some exemplary embodiments, the method 500 can first determine the peak current and the mid current for the conducting elements from the overall drive current. The method 500 then determines a first intermediate zero vector in response to a ratio of the diode conduction loss and the transistor conduction loss at the peak current. The method next determines a second intermediate zero vector in response to a ratio of the transistor conduction loss at the peak current and the transistor conduction loss at the mid current or the ratio of the diode conduction loss at the mid current and the diode conduction loss at the peak current depending on which component temperature is greater. The adapted zero vector is then determined in response to a maximum and minimum of the first intermediate zero vector and the second intermediate zero vector.

The method 500 is next operative to apply 575 the adapted zero vector to the drive current having an initial zero vector to generate a drive current with a final zero vector. The final zero vector is applied 545 to the PWM inverter such that adapted PWM three phase drive currents are generated 580 having the adjusted zero vector in order to balance the temperature distribution over the conducting diodes and switches within the PWM inverter. The PWM three phase drive currents are then coupled to the drive motor to power 585 the drive motor and the method 500 returns to estimating 520 subsequent junction temperatures.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A motor control system comprising:
an inverter having a diode and a transistor for generating an alternating current in response to a pulse width modulated direct current having a fixed amplitude; and
a processor configured to adjust a zero vector of the pulse width modulated direct current in response to a diode temperature and a transistor temperature such that the diode temperature equals the transistor temperature.

2. The motor control system of claim 1, further including a memory for storing a first component loss for the transistor and a second component loss for the diode.

3. The motor control system of claim 1, wherein the alternating current is coupled to a stator winding of an electric motor to drive a rotor of the electric motor.

4. The motor control system of claim 1, wherein the zero vector is adjusted in response to a first component loss for the transistor, a second component loss for the diode and a portion of the pulse width modulated direct current coupled through the transistor and the diode.

5. The motor control system of claim 1, wherein the diode temperature is determined by a first temperature sensor and the transistor temperature is determined by a second temperature sensor.

6. The motor control system of claim 1, wherein the zero vector is adjusted by increasing a transistor conduction time and decreasing a diode conduction time.

7. The motor control system of claim 1, further including an electric motor driven by the alternating current and wherein the processor is configured to adjust the zero vector in response to a detection of a stall condition of an electric motor.

8. The motor control system of claim 1, wherein the zero vector is adjusted in response to a diode conduction loss, a diode voltage drop, a transistor conduction loss and a transistor voltage drop.

9. The motor control system of claim 1, wherein at least one of the diode temperature and the transistor temperature are determined using a negative temperature coefficient thermistor.

10. A method of generating an alternating current comprising:
generating a pulse width modulated current having a first zero vector;
estimating a diode temperature and a transistor temperature in an inverter in response to the pulse width modulated current;
adjusting the first zero vector of the pulse width modulated current to generate an adapted pulse width modulated current such that the diode temperature equals the transistor temperature;
generating, by the inverter, an alternating current in response to the adapted pulse width modulated current; and
coupling the alternating current to an electric motor.

11. The method of generating an alternating current of claim 10, wherein the diode temperature is estimated in response to a diode voltage drop across a diode and the transistor temperature is determined in response to a transistor voltage drop across a transistor.

12. The method of generating an alternating current of claim 10; wherein the diode temperature is determined using a first negative temperature coefficient thermistor and the transistor temperature is determined using a second negative temperature coefficient thermistor.

13. The method of generating an alternating current of claim 10, wherein the first zero vector is adjusted by adjusting a diode conduction time and a transistor conduction time.

14. The method of generating an alternating current of claim 10, wherein the first zero vector is adjusted in response to the diode temperature exceeding a threshold temperature.

15. The method of generating an alternating current of claim 10, wherein the diode temperature equals the transistor temperature when the diode temperature is within one percent of the transistor temperature.

16. The method of generating an alternating current of claim 10, wherein the first zero vector is adjusted in response to the electric motor being in a stall condition.

17. The method of generating an alternating current of claim 10, wherein the first zero vector is adjusted in response to the transistor temperature exceeding the diode temperature.

18. The method of generating an alternating current of claim 10, wherein the diode temperature is determined in response to a voltage drop across the diode and at least one of a magnitude of the pulse width modulated current and a duty cycle of the pulse width modulated current.

19. A vehicle propulsion system comprising:
a battery configured to supply a direct current;
a generator for generating a pulse width modulated current in response to the direct current and a zero vector;
an inverter having a diode and a transistor for converting the pulse width modulated current to an alternating current;
a processor for determining a diode temperature of the diode and a transistor temperature of the transistor and for adjusting the zero vector such that the diode temperature equals the transistor temperature; and
an electric motor for propelling a vehicle in response to the alternating current.

20. The vehicle propulsion system of claim 19, wherein the diode temperature is estimated in response to a first voltage drop across the diode and a duty cycle of the pulse width modulated current and the transistor temperature is estimated in response to a second voltage drop across the transistor and the duty cycle of the pulse width modulated current.
